(19) United States
(12) Patent Application Publication
(10) Pub. No.: US 2006/0090971 A1
(43) Pub. Date: May 4, 2006

(54) Drive unit comprising a retarder

(75) Inventors: Klaus Vogelsang, Crailsheim (DE); Peter Heilinger, Satteldorf (DE)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Voith Turbo GMBH & Co. KG, Heidenheim (DE)

(21) Appl. No.: 10/527,262

(22) PCT Filed: Sep. 15, 2003
(86) PCT No.: PCT/EP03/10249

§ 371 Date: Oct. 4, 2005

(30) Foreign Application Priority Data
Sep. 13, 2002 (DE) 102 42 736.4

(51) Int. Cl. F16D 57/02

(52) U.S. Cl. 188/296

(57) ABSTRACT

A drive unit for a motor vehicle with a cooling system is provided. The drive unit has a hydrodynamic retarder with a rotor vane wheel and a stator vane wheel. The hydrodynamic retarder is arranged in the vehicle cooling circuit and the working medium of the retarder is also the vehicle cooling medium. The retarder can empty a residual liquid quantity against the outside pressure created by the cooling system.

The invention relates to a drive unit, specifically one with the features taken from the preamble of claim 1.

A retarder is often integrated into the drive systems of vehicles or stationary equipment as means for reducing speed or the rpm. The retarder is switched on or off by filling and emptying the blade-mounted working circuit with an operating fluid for use in motor vehicles or for equipment with strongly changing operation.

The stationary or traveling units—for example, motor vehicles—in which the named drive units are installed, usually have additional assemblies, which require cooling. To be considered here are, for example, motors, brakes, clutches, and transmissions.

These other assemblies can also have a cooling circuit in order to cool their working medium.

Retarders in which the working medium of the retarder is the cooling medium of the vehicle have become known from a number of patents. Reference in this regard is made to

EP 0 716,996 A1

WO 98/15725

EP 0 885,351 B1

EP 0 932,539 B1.

the disclosure of which is incorporated in full into the present application.

A drawback of the retarders known from these documents is their high power loss in non-braking operation.

<page 2a>[handwritten]

The problem of the invention is to minimize the power loss in drive units with retarders of this kind.

The problem is solved by a drive unit with the features of claim 1. In a special embodiment of the invention, a cylinder is employed for aspirating a quantity of residual fluid of the working medium in non-braking operation.

The power loss can be minimized still further if the rotor and/or stator is designed in such a manner that it can shift axially, so that, in non-braking operation, a large gap is created between rotor and stator. A solution of this kind is described in WO 98/35171 for a retarder operated with oil. The disclosure content of this document is incorporated in full into the present application.

Further advantageous embodiments of the invention are the subject of the subclaims. The invention will be described below on the basis of figures.

Shown are:

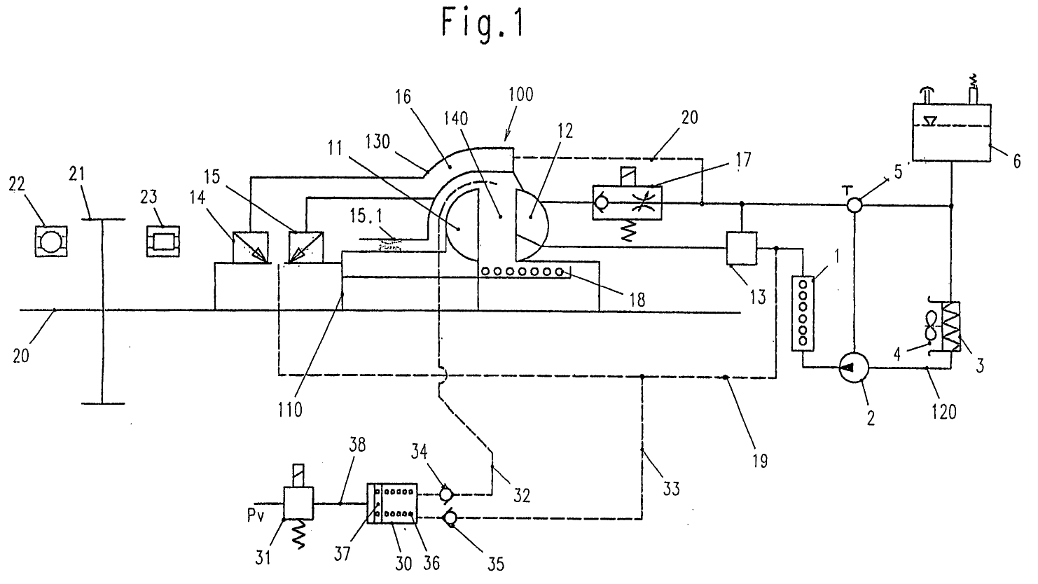

FIG. 1 a first embodiment of the invention;

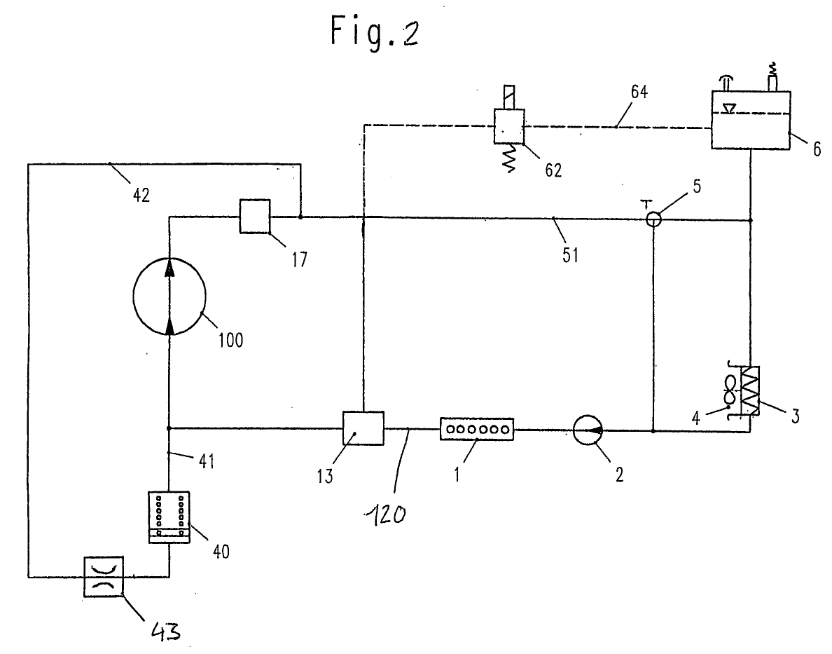

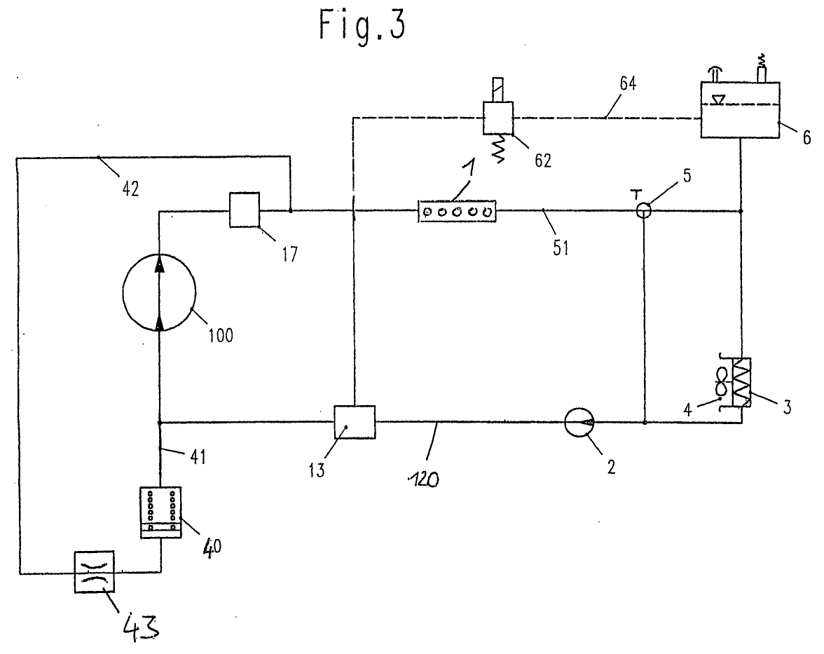

FIGS. 2 and 3 a second embodiment of the invention;

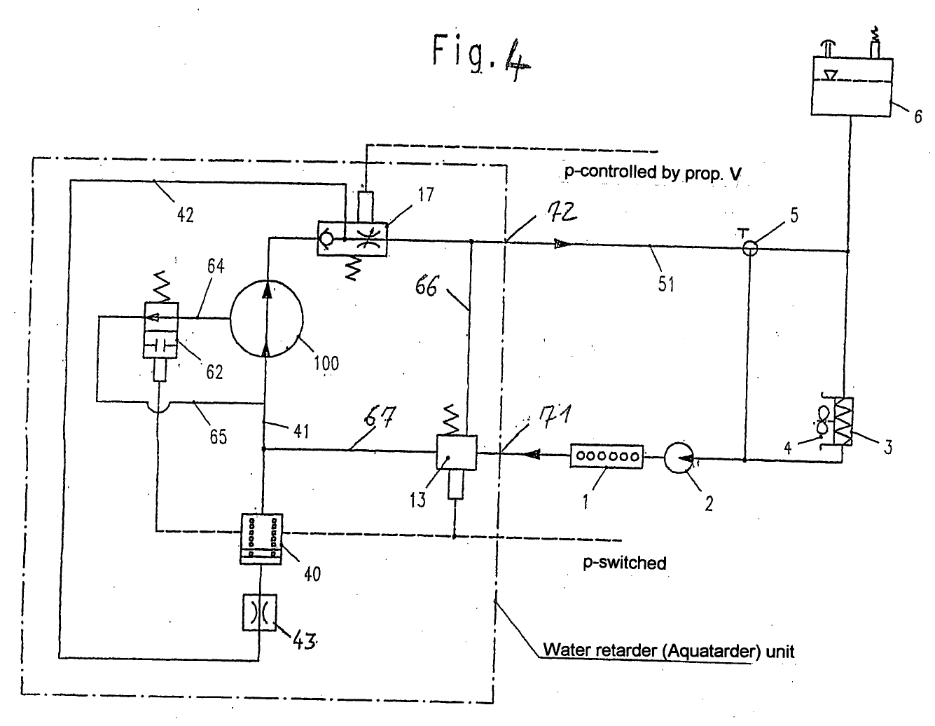

FIG. 4 a third embodiment of the invention.

The document U.S. Pat. No. 3,924,713, which may be regarded as representative for the nearest prior art, shows a retarder for which a device for aspirating the gaseous volume out of the interior of the retarder working chamber is provided and by means of which the retarder can be filled more rapidly and a desired braking moment can be attained more rapidly. The features known from this document are summarized in the preamble of claim 1.

According to a first measure, the rotor impeller 11 is held in an axially displaceable way on the rotor shaft 110, so that the rotor 11 can be moved to a working position close to stator 12 or an idle position at a large distance from the stator 12 in non-braking operation. FIG. 1 shows the retarder in the idle position. Reference is hereby made to WO 98/35171 concerning the displaceability of the rotor.

The retarder as shown in FIG. 1 comprises a rotor 11 which is held in a torsionally rigid and overhung manner on a rapidly rotating shaft 110 (the so-called retarder shaft) which is held in a transmission for example. The shaft 110 with bearings 22 and 23 is driven via a pinion 21 by the driven shaft of a transmission (not shown). The rotor 11 is longitudinally movable on shaft 110 by means of a spiral gearing (not shown), so that the distance between the rotor and stator can be set. The spring 18 displaces the rotor 11 in the non-braking operation to the low-loss position (as shown here), i.e. between the rotor and stator 12 the largest possible gap is obtained. The retarder has a retarder housing 130 with an inner space 16. The inner space 16 can be filled with a cooling medium and can then act as a cooling jacket. The space between rotor 11 and stator 12 is designated the working chamber 140 and is filled with working medium. The hydrodynamic retarder is integrated in the cooling circulation 120 of the motor vehicle. As a result, the working medium of the retarder is simultaneously the cooling medium of the motor vehicle in the illustrated embodiment of the retarder. In order to keep the power losses at a low level, the retarder needs to be emptied in non-braking operation, with emptying also meaning an emptying to a predetermined residual quantity of working medium which advantageously leads to a minimal power loss.

The emptying processing which is produced substantially by the pumping action of the rotor 11 is controlled substantially by the control valve 17, but is obstructed in the end by the superposition pressure which is predetermined in the compensator reservoir 6 of the vehicle cooling system by a pressure control valve.

As a result of the counter-pressure in the cooling circulation of the vehicle, the retarder has a residual filling which according to the outer counter-pressure leads to an undesirably high power loss. That is why a portion of the unavoidable residual filling is sucked from the retarder circulation by a cylinder 30 in the non-braked state in the first embodiment of the invention as shown in FIG. 1 in addition to the gap enlargement between rotor 11 and stator 12. The removed quantity is dimensioned to such an extent that the retarder circulation is always operated in power loss minimum.

In the first embodiment of the invention as shown in FIG. 1, the cylinder 30 is connected via line 32 with the retarder circulation and via line 33 with the cooling water circulation, i.e. with a part of the external circulation to which the internal retarder circulation is connected. Moreover, line 32 comprises a return valve 34 and line 33 comprises a return valve 35. The state “brake off” as shown in FIG. 1, i.e. the state of non-braking operation, is produced via the valve 31 through venting line 38. The piston 37 in cylinder 30 is brought to a position by spring 36 in which the required water quantity is sucked from the retarder circulation via line 32 and the return valve 34 in order to achieve the desired power loss minimum. This process is repeated regularly after each deactivation of the retarder. The volume of the cylinder 30 is dimensioned in such a way that the disturbing quantity of residual liquid which leads to undesirable retarder losses in non-braking operation is taken up in a secure manner. The compensating reservoir 6 is configured in such a way that such residual liquid quantity will not lead to disturbances in the cooling system. Such disturbances are principally possible because the retarder system removes cooling medium from the closed cooling water circulation of the motor vehicle and also emits the same. This leads to differing cooling water levels in the compensating reservoir.

In the embodiment as shown in FIG. 1, the hydrodynamic retarder comprises three different gaskets. There is a gasket 14 which is flushed continually with coolant and which is preferably an axial face gasket with absolute tightness to the outside towards the atmosphere. A further gasket 15 needs to fulfill two tasks in its sealing function. In the non-braking operation the cooling fluid which can flow through the inner space 16 of the retarder housing as a cooling flow via line 19 is sealed absolutely in the direction towards rotor and stator, which means that the gasket 15 assumes the sealing function in non-braking operation. An axial face seal 15.1 acts in braking operation as a contact-free labyrinth seal and the cooling liquid flows through the gasket 15 which in this case does not assume any sealing. This can be achieved in such a way that the gasket 15 is configured in such a way that it is permeable by a predetermined amount in the direction from the interior of the retarder to the ambient environment (i.e. in the direction to the left in FIG. 1) and is configured in a tight or substantially tight manner in the direction from the ambient environment to the interior of the retarder (i.e. to the right in FIG. 1). As a result of the pressure drop via gasket 15 in braking operation it is ensured that the pressure level of the closed (external) cooling system is applied to gasket 14.

The inner space 16 is configured in such a way that it functions as a heat-dissipating cooling jacket of the retarder, such that the cooler medium flows in via line 19 and can flow off via line 20.

FIGS. 2 and 3 show alternative embodiments of the invention which are characterized in that the cylinder 40 which is equipped with a piston and a spring is integrated in the retarder system via lines 41 and 42 in such a way that the function of “sucking off residual liquid quantity” runs automatically.

The residual liquid quantity is sucked off from the retarder in non-braking operation via line 41 which is connected at a location of low pressure in the coolant circuit of the vehicle, i.e. in the direction of flow before the working chamber of the retarder, by means of the piston which is pressurized by the pressure spring. The pressure spring in cylinder 40 overcomes the pressure in line 42 in non-braking operation, which pressure is comparatively low in non-braking operation due to the emptied retarder.

For braking operation, the pump 2 is triggered and filled with coolant liquid via the changeover valve 13 of the retarder 100. High or highest pressure prevails in line 42 now in braking operation, which line is connected on the side of the piston which is opposite of the pressure spring in cylinder 40, because the line 42 (as can be seen in FIG. 2) is connected in the direction of flow behind the working chamber of the retarder. The connection of line 42 in the direction of flow behind valve 17 is only provided as an example. As will be explained below with reference to FIG. 4, the connection can also be advantageously within valve 17, namely between return valve and throttle. The pressure generated by the retarder is thus transmitted via line 42 onto the side of the piston which is opposite of pressure spring in cylinder 40. The residual liquid quantity situated in cylinder 40 is automatically returned for braking operation again to the retarder circulation or the retarder against the pressure of the spring force of the spring situated in cylinder 40. The cylinder 40 is thus in the position to suck off the residual liquid quantity for the next cut-off phase, i.e. the non-braking operation.

The embodiment according to FIG. 3 corresponds substantially to the embodiment according to FIG. 2. The same components are designated with the same reference numerals as in FIG. 2. One difference lies in the arrangement of the retarder circulation in the coolant circulation 120 of the vehicle. When the retarder is activated, the branch of the coolant circulation with the retarder 100 is incorporated in FIG. 3 between the coolant pump 2 and the motor 1. In FIG. 2 on the other hand, this cooling branch was incorporated in the coolant circulation behind the motor 1. As in the embodiment according to FIG. 2, a pressure cut-off valve 62 which can be changed over to pass-through is provided and a pressure relief line 64 which is connected with the compensating reservoir 6. The pressure cut-off valve 62 is arranged in the pressure relief line 64 and is opened upon the occurrence of high pressure peaks, e.g. an impulse shock during the emptying of the retarder. As a result of this additional measure, pressure peaks occurring during the retarder operation in the cooling circulation can be removed. Such pressure peaks occurs especially during activation and deactivation or abrupt changes in load of the retarder. The pressure relief line 64 is connected directly with the compensating reservoir 6.

FIG. 4 shows a further development of the invention. The illustrated block diagram shows measures which were taken in order to substantially prevent a pressure surge in the system (and especially in line 51) during the transition from braking operation to non-braking operation of the retarder 100. Moreover, measures are shown which can be provided in addition or as an alternative in order to avoid a pressure surge or a surge-like pressure drop in the transition from the non-braking operation to braking operation.

The first measures (avoidance of cut-off surge) are substantially embodied by the pressure-switched valve 62 with the connected lines 64 and 65. Line 64 is arranged with its end averted from valve 62 in a high-pressure zone of the cooling circulation. This can be in the region of the working medium outlet of the retarder or a discharge conduit which is formed in the retarder housing. A pressure of 11 bar can prevail there at the beginning of the non-braking operation for example. A further advantageous possibility for connection is obtained with the position between the return valve shown there and the adjustable throttle in the control valve 17. A pressure of 30 bar can prevail there for example.

Line 64 is connected with its end averted from valve 62 in a low-pressure zone. A pressure of not more than 2 bar advantageously prevail there. The connection can be provided in the region of the inlet of the retarder for example, especially at a filling channel which is formed in the retarder.

The triggering of the valve 62 advantageously occurs with the same switching impulse which also triggers valve 13. Both valves are especially switched by a pressure surge (p-switched). In the transition from braking operation to non-braking operation, the valve 62 is switched from a closed position to an opened position. A short-circuit flow via the retarder 100 is thus obtained, meaning that the working medium (and in this case the coolant of the vehicle) flows for the said high-pressure zone via lines 64 and 65 to the said low pressure zone. As a result, an ejection of the entire working medium which was received in braking operation by the retarder or the connected piping is supplied in a delayed manner to line 51 because a considerable quantity is held back at first in the region of the retarder 100 by the short-circuit flow. A pressure surge is thus prevented in line 51. The coolant circulation between the valve 13 and the valve 17 via the retarder 100 and the lines connected to the same is thus emptied in an even manner.

The optimal residual quantity of working medium in the retarder in non-braking operation is set by means of cylinder 40. As can be seen, the cylinder 40 is connected in this embodiment via line 42 with a high-pressure region between the return valve and the adjustable throttle of the control valve 17. In line 42, a throttle 43 is switched, so that during the transition from non-braking operation to braking operation the liquid quantity sucked off from cylinder 40 for reducing the power loss is returned in a controlled manner to the pressure-loaded line system via line 41.

In order to achieve an optimal non-braking operation, i.e. the lowest possible power loss in non-braking operation, the control valve 17 is advantageously configured in such a way that it seals in non-braking operation the cooling circulation of the vehicle (starting with line 51) completely against the line branch with the retarder 100. The same applies to the valve 13 which also completely seals in non-braking operation the cooling circulation of the vehicle (starting with the line branch in which the motor 1 is shown) against the line region in which the retarder 100 is arranged. The valve 13 is moreover switched in non-braking operation in such a way that the entire arriving coolant quantity is guided via line 66 to line 51.

In order to avoid an activation surge as indicated above, the valve 13 can be switched to an intermediate position during the transition from the non-braking operation to braking operation of the retarder, so that at first only a part of the cooling medium is guided via line 67 to retarder 100, whereas another part is guided further via line 66 to line 51 and thus remains in the vehicle cooling circulation without having been guided through the retarder.

As is further indicated in FIG. 4 by the dot-dash line, predetermined individual components can be integrated into a water retarder unit 70. This water retarder unit 70 as configured in accordance with the invention comprises in one embodiment the retarder 100 and a means for emptying a residual liquid quantity against an outside pressure built up by the cooling system to which the water retarder unit 70 is connected. In a special embodiment, this means for emptying is the illustrated cylinder 40, especially in combination with the throttle 43, the control valve 17 and the changeover valve 13. In an especially advantageous embodiment, the water retarder unit 70 further comprises pressure relief lines 64 and 65 with the interposed pressure cut-off valve 62. It is understood that connection points are advantageously connected to the water retarder unit 70 for pressure control or pressure regulation, e.g. for pressure switching the valve 13 and for pressure regulating the valve 17. The other lines enclosed by the dot-dash line are also advantageously integrated in the water retarder unit 70, so that they can be connected as flexibly applicable standard components to a coolant circulation of a motor vehicle, with the water retarder unit 70 being provided especially with precisely one connection 71 for supplying cooling medium and a single connection 72 for removing cooling medium.

As a result of the present invention, a drive system is provided for the first time in which the retarder is integrated in the coolant circulation of the vehicle and a minimization of the power loss is achieved by purposeful emptying of the retarder in non-braking operation to a predetermined residual liquid quantity. Moreover, the occurrence of pressure surges in the system can be prevented effectively by the further measures as explained herein.

### LIST OF REFERENCE NUMERALS

1 Engine
2 Pump
3 Radiator
4 Impeller
5 Thermostat
6 Compensating reservoir
11 Rotor
12 Stator
13 Changeover valve
14 Gasket
15 Gasket
15.1 Axial face seal
16 Inner space
17 Control valve
18 Spring
19 Line
20 Line
21 Pinion
22, 23 Bearing
30 Cylinder
31 Valve
32, 33 Line
34, 35 Return valve
36 Spring
37 Piston
38 Line
40 Cylinder
41, 42 Line
43 Throttle
62 Pressure cut-off valve
64 pressure relief line
65 pressure relief line
66 line
67 line
70 water retarder unit
71, 72 cooling medium connection
100 retarder
110 shaft
120 cooling circulation
130 retarder housing
140 working chamber

1-17. (canceled)

18. A drive unit for a vehicle with a cooling system having a cooling circuit and a medium, the drive unit comprising:
a hydrodynamic retarder having a rotor blade wheel and a stator blade wheel, wherein the hydrodynamic retarder is operably connected to the cooling system and uses the medium of the cooling circuit; and
a discharging device for discharging a residual amount of liquid of the medium against a pressure of the cooling system in a non-braking operation.

19. The drive unit of claim 18, wherein the discharging device suctions off the residual amount of liquid from the hydrodynamic retarder.

20. The drive unit of claim 18, wherein the discharging device comprises at least one cylinder operably connected with the cooling circuit or the hydrodynamic retarder via a first conduit.

21. The drive unit of claim 20, wherein the at least one cylinder is operably connected via the first conduit with the cooling circuit to a point of highest pressure in the cooling system.

22. The drive unit of the claim 21, further comprising an adjustable throttle operably connected to the first conduit with the at least one cylinder and the point of highest pressure.

23. The drive unit of claim 18, wherein the discharging device further comprises a switchable valve.

24. The drive unit of claim 21, wherein the at least one cylinder is operably connected via a second conduit with the cooling circuit to a point of lowest pressure in the cooling system.

25. The drive unit of claim 24, wherein the first conduit connected to the point of highest pressure in the cooling system and the second conduit connected to the point of lowest pressure in the cooling system are connected at opposite sides of a piston in the at least one cylinder, and wherein the piston is pressurized by a pressure spring biasing the piston against pressure supplied through the second conduit.

26. The drive unit of claim 18, further comprising a pressure relief line having a pressure cut-off valve connected to the cooling system or the hydrodynamic retarder, wherein the pressure cut-off valve is operably connected with the pressure relief line thereby opening during a transition of the hydrodynamic retarder from a braking operation to the non-braking operation.

27. The drive unit of claim 26, wherein the pressure relief line has first and second ends, the first end being connected at a point of low pressure upstream of the hydrodynamic retarder, the second end being connected at a point of high pressure at or downstream of the hydrodynamic retarder, and wherein the low pressure is at or below 2 bars and the high pressure is between 11 bars and 30 bars.

28. The drive unit of claim 18, further comprising an engine and a transmission, wherein the hydrodynamic retarder is a secondary retarder which is arranged behind the transmission in a direction of force flow.

29. The drive unit of claim 18, wherein the discharging device comprises a cylinder having a piston, wherein the piston is pressurized by a first high pressure on one side of the piston via a first line connected to a point of high pressure in the cooling circuit downstream of the hydrodynamic retarder, and wherein the piston is pressurized with a second low pressure on an opposite side of the piston via a second line connected to a point of low pressure in the cooling circuit upstream of the hydrodynamic retarder.

30. The drive unit of claim 29, further comprising a throttle operably connected to the first line.

31. The drive unit of claim 29, further comprising a pressure cut-off valve in a pressure relief line, wherein a first end of the pressure relief line is connected to a point of high pressure at or downstream of the hydrodynamic retarder in the cooling circuit, and wherein a second end of the pressure relief line is connected to a point of low pressure upstream of the hydrodynamic retarder in the cooling circuit.

32. The drive unit of claim 31, further comprising a changeover valve, wherein the first line has a distal end opposite to the cylinder that is connected to a control valve, wherein the changeover valve selectively directs the medium either through the hydrodynamic retarder or by-passes the hydrodynamic retarder via a by-pass, and wherein the control valve, the pressure cut-off valve and the changeover valve are controlled by pressurization.

33. The drive unit of claim 32, wherein the hydrodynamic retarder further comprises a first single connection for supplying the medium and a second single connection for discharging the medium.

34. The drive unit of claim 32, wherein the control valve is bypassed when the changeover valve selectively directs the medium to by-pass the hydrodynamic retarder.
